(19) United States
(12) Patent Application Publication
(10) Pub. No.: US 2017/0154389 A1
(43) Pub. Date: Jun. 1, 2017

(54) METHODS AND SYSTEMS FOR MAKING TRAVEL ARRANGEMENTS

(71) Applicant: DEEM, INC., San Francisco, CA (US)

(72) Inventors: Gad BASHVITZ, San Francisco, CA (US); Scott Heavner, Alameda, CA (US)

(21) Appl. No.: 15/285,422

(22) Filed: Oct. 4, 2016

Related U.S. Application Data
(63) Continuation of application No. 14/060,542, filed on Oct. 22, 2013, now abandoned.

(51) Int. Cl. G06Q 50/14; G06Q 10/10; G06N 99/00; G06Q 10/02

(52) U.S. Cl. CPC G06Q 50/14; G06Q 10/02; G06Q 10/1093; G06N 99/005

(57) ABSTRACT

A computer-implemented method for making travel arrangements for a traveler comprises determining a travel schedule of the traveler, and conducting, with the aid of a processor, a search directed to travel options that coincide with the travel schedule and traveler preferences, and storing available travel options in one or more memory locations. Next, one or more travel options from the available travel options are selected. In some situations, the one or more travel options are selected without any involvement from the traveler. The traveler may then be notified about the one or more travel options that were selected.

### CROSS-REFERENCE

This application is a continuation of U.S. patent application Ser. No. 14/060,542, filed Oct. 22, 2013, which claims priority to U.S. Provisional Patent Application Ser. No. 61/717,596, filed Oct. 23, 2012, each of which is entirely incorporated herein by reference.

### BACKGROUND

A travel agency is a private retailer or public service that may provide tourism related services to the public on behalf of suppliers, such as airlines, car rentals, cruise lines, hotels, railways, and package tours. Travelers frequently make travel arrangements using travel agencies. Some travel agencies have a presence on the internet and provide software that enables travelers to make travel arrangements on the World Wide Web. Such software may provide a traveler with available flights, hotels, rental cars and activities from which a traveler may make a selection. Such software may enable the traveler to input a date and time of a desired flight, and a flight starting point and destination.

### SUMMARY

While there are flight, hotel, rental car and activity booking systems and methods currently available, recognized herein are various limitations with such systems and methods. For example, travel software presently available may not permit a traveler to book a flight, hotel or activities that coincides with the traveler's travel schedule and meet their personal preferences without any involvement from the traveler. Current systems may not proactively detect the need to book travel in order to offer booking options automatically without the traveler initiating the booking. Moreover, current systems may not categorize traveler sentiment towards different hotel, flight and rental car attributes in order to optimize booking matching to traveler preferences and offering them the inventory that may best fit their personal preferences.

This disclosure provides systems and methods for automating travel and accommodation booking, including searching for and booking flights, hotels, rental cars other transportations needs and activities. Systems provided herein can lean from and adapt to a traveler's preferences, and automatically shop for and book a flight, hotel, rental cars and activities for travelers, in some cases without any traveler involvement.

An aspect of the present disclosure provides a computer-implemented method for making travel arrangements for a user, the method comprising (a) determining a travel schedule of the user; (b) using a computer processor, conducting a search directed to travel options that coincide with the travel schedule, and storing available travel options in memory; (c) selecting one or more travel options from the available travel options; and (d) notifying the user of the one or more travel options selected in (c). In an embodiment, the method further comprises directing an electronic communication to the user to notify the user of the one or more travel options selected in (c). In another embodiment, the electronic communication is an electronic mail. In another embodiment, the one or more travel options are selected based upon a comparison of the available travel options to travel preferences of the user in memory operatively coupled to the computer processor. In another embodiment, the available travel options are weighted by any two attributes selected from star rating, user review, price and distance. In another embodiment, in (a), the travel schedule is determined by: accessing an electronic mail account of the user, which electronic mail account comprises one or more electronic mails; reviewing the one or more electronic mails to identify content that is indicative of the travel schedule; and determining the travel schedule from the identified content. In another embodiment, the content is text and/or graphical information. In another embodiment, in (a), the travel schedule is determined by accessing an electronic calendar of the user and identifying text that is indicative of the travel schedule. In another embodiment, the text comprises a date and destination location. In another embodiment, determining the travel schedule of the user comprises: receiving an invitation to a meeting from the user, wherein the invitation coincides with a travel schedule of the user; accepting the meeting invitation; and determining the travel schedule from the meeting invitation. In another embodiment, the one or more travel options are selected from the available travel options without any involvement from the user.

Another aspect of the present disclosure provides a computer-implemented method for making travel arrangements for a user, the method comprising (a) determining a travel schedule of the user; (b) using a computer processor, conducting a search directed to travel options that coincide with the travel schedule, and storing available travel options in memory; (c) presenting one or more travel options from the available travel options to the user; and (d) receiving the selection of a given travel option from the one or more travel options from the user. In an embodiment, the available travel options are weighted by any two attributes selected from star rating, user review, price and distance. In another embodiment, in (a), the travel schedule is determined by: accessing an electronic mail account of the user, which electronic mail account comprises one or more electronic mails; reviewing the one or more electronic mails to identify content that is indicative of the travel schedule; and determining the travel schedule from the identified content. In another embodiment, the content is text and/or graphical information. In another embodiment, in (a), the travel schedule is determined by accessing an electronic calendar of the user and identifying text that is indicative of the travel schedule. In another embodiment, the text comprises a date and destination location. In another embodiment, determining the travel schedule of the user comprises: receiving an invitation to a meeting from the user, wherein the invitation coincides with a travel schedule of the user; accepting the meeting invitation; and determining the travel schedule from the meeting invitation. In another embodiment, the one or more travel options are selected from the available travel options without any involvement from the user. In another embodiment, in (c) the one or more travel options are presented on a user interface (UI) of an electronic device of the user, which UI presents a given travel option and at least two attributes of the travel option selected from star rating, user review, price and distance.

Another aspect of the present disclosure provides a method for prioritizing travel options, the method comprising (a) receiving a request from a user for a travel option, wherein the request comprises a geographic location selected by the user; (b) using a computer processor, searching a database of travel options for one or more travel options that match the request of (a), which match is based on a comparison between (i) one or more travel option preferences of the user as maintained in a profile of the user, and (ii) a score of a given travel option in the database that is weighted by any two attributes selected from star rating, user review, price and distance from the geographic location; and (c) based on the search of (b), providing one or more travel options that match the request. In an embodiment, the method further comprises receiving a request form a user to book a given travel option among the one or more travel options. In another embodiment, the method further comprises booking the given travel option without any additional involvement from the user. In another embodiment, the method further comprises selecting travel option amenities and service elements that match the one or more travel option preferences. In another embodiment, the one or more travel option preferences comprise user review sentiments. In another embodiment, the match employs the use of a machine learning algorithm that takes user feedback and preferences into account and adapts the matching process based on the preferences. In another embodiment, the travel option is a hotel or flight.

Another aspect of the present disclosure provides machine executable code that, upon execution by a computer processor, implements any of the methods above or elsewhere herein.

Another aspect of the present disclosure provides a system comprising a computer processor and a memory location comprising machine executable code that, upon execution by the computer processor, implements any of the methods above or elsewhere herein.

Another aspect of the present disclosure provides a system for making travel arrangements for a user. The system comprises (a) a database of available travel options; (b) a computer processor that is programmed to (i) conduct a search of the database directed to travel options that coincide with a travel schedule of the user, (ii) weigh available travel options by any two travel option attributes selected from star rating, user review, price and distance, and (iii) store weighted available travel options in memory; and (c) an output that provides available travel options to the user. In an embodiment, the computer processor is programmed to determine the travel schedule. In another embodiment, the output is an electronic display on an electronic device of the user. In another embodiment, the computer processor is programmed to compare the available travel options to travel preferences of the user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the claimed invention are set forth with particularity in the appended claims. A better understanding of the features and advantages of the present invention will be obtained by reference to the following detailed description that sets forth illustrative and non-limiting embodiments, in which the principles of the invention are utilized, and the accompanying drawings or figures (also “FIG.” or “FIGs.” herein) of which:

FIG. 1 schematically illustrates a method for selecting travel options for a traveler;

FIG. 2 schematically illustrates a method for joining a meeting of a traveler and selecting travel options for the traveler;

FIG. 3 schematically illustrates a method for populating a database of a system with travel options;

FIG. 4 schematically illustrates a method for registering a traveler with the system;

FIG. 5 schematically illustrates a method for searching for and booking travel options;

FIG. 6 schematically illustrates a system for facilitating methods of the disclosure; and

FIG. 7 is a screenshot that shows a meeting invitation;

FIG. 8 is a screenshot that shows a traveler inviting the system to a meeting;

FIG. 9A is a screenshot that shows the traveler having inputted various travel details.

FIG. 9B is a screenshot that shows the traveler having added the system (“Travel Buddy”) to the list of participants of the meeting, which can be provided a meeting invitation;

FIG. 10 is a screenshot that shows the traveler receiving an email from a server providing information about a trip and asking the traveler for confirmation about various booking boundaries;

FIG. 11 shows an electronic communication similar to that of FIG. 10 received on a Smart phone of the traveler;

FIG. 12 is a screenshot of a confirmation from the traveler of trip details or the amount of money the traveler would prefer to pay;

FIG. 13 is a screenshot of the system providing the traveler a clarification question (e.g., through an email, text, app or speech interface);

FIGS. 14A, 14B and 14C show screenshots of a confirmation email with booked travel options;

FIGS. 15A and 15B show screenshots of a confirmation screen on a graphical user interface (GUI) shown on a display of a Smart phone of the traveler;

FIG. 16 is a screenshot of a calendar of a traveler on a display of a personal computer;

FIG. 17 is a screenshot of a calendar of a traveler on a display of a Smart phone;

FIG. 18 is a screenshot of traveler preferences;

FIG. 19 is a screenshot showing sample of amenities that travelers can select as part of preferences;

FIG. 20 is a screenshot that shows three hotel results returned by system of the present disclosure;

FIG. 21 is a screenshot that provides insight into why a specific hotel was selected;

FIG. 22 shows normalized price score as a function of hotel price as fraction of customer maximum (1.0=100%); and

FIG. 23 shows normalized distance score as a function of hotel distance as fraction of customer maximum (1.0=100%).

FIGS. 24A and 24B show screenshots from an example method for proactively offering personalized hotel booking options to a user of a virtual assistant application based on the user adding a “To do” task within the application or the system detecting a need of the user to travel based on entries in the user's calendar.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

This disclosure provides systems and methods for making travel arrangements for a traveler, in some cases without any traveler involvement. Some examples provide a system that automatically searches for and makes travel arrangements (e.g., book a flight or hotel) without any involvement from the traveler.

### Methods for Booking Travel Options

An aspect of the invention provides a method for making travel arrangements for a traveler. The method comprises determining a travel schedule of the traveler, and conducting, with the aid of a processor, a search directed to travel options that coincide with the travel schedule. The available travel options are then stored in one or more memory locations. One or more travel options are then selected from the available travel options. The one or more travel options are selected without any involvement from the traveler. This can be achieved based on a deep knowledge of the traveler's preferences which were previously collected and stored. The traveler is then notified of the one or more travel options selected for the traveler.

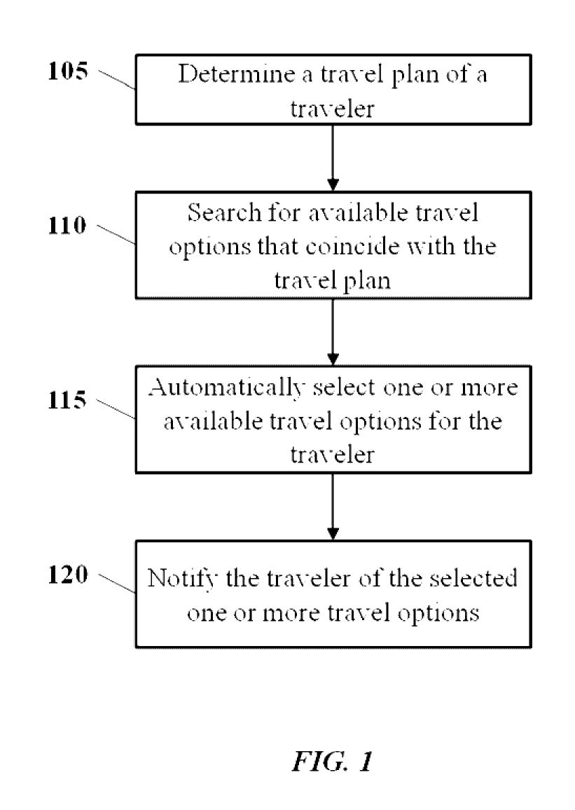

FIG. 1 shows a method for making travel arrangements for a traveler. The method can be implemented with the aid of a computer system having a processor programmed to execute machine readable code the implements the method (see below). In a first operation 105, the system determines a travel plan (or schedule) of the traveler. The travel plan can include a start date and time and, in some cases, an end date and time of the travel schedule of the traveler. The travel plan can also include a start location (e.g., city, country, address) and a destination location of the travel schedule of the travel. For instance, the travel schedule can include a starting point (e.g., San Francisco, Calif.) of the traveler's travel schedule, and a destination point (e.g., New York, N.Y.) of the traveler's schedule.

In a second operation 110, the system conducts a search for available travel options that coincide with the travel plan and the traveler's preferences. The available travel options can include one or more available travel options, such as, for example, multiple flights. Each of the one or more available travel options can at least partially coincide with the travel plan of the traveler. The one or more available travel options can be stored in one or more memory locations of the system. The one or more memory locations can be coupled to the processor of the system.

Next, in a third operation 115, the system automatically selects one or more available travel options from the travel options revealed in the search. The system can either automatically book each travel option for the traveler or let the traveler complete a one-step (1 step) booking. In one-step booking, the system can book any one, two or all three of a flight, hotel and car for the traveler in a single step. For example, the system can book a hotel for the traveler. The system can automatically select various travel options for the traveler, including flight options, hotel options, ground transportation options, and food and/or drink options. In some cases, the system can select a travel option for the traveler by directing a notification to a provider of the option (e.g., hotel, airline) that the travel option is to be booked or otherwise reserved for the traveler.

Next, in a fourth operation 120, the system notifies the traveler of the one or more travel options selected by the system for the traveler. The system can either display the results on the screen or direct an electronic communication to the traveler, such as an electronic mail (“email”), instant message, text message, or push notification on an electronic device of the traveler.

The system can charge the traveler for the transaction including the selection of the one or more travel options. The system can request that the traveler provide payment for the transaction, such as providing electronic funds. As an alternative, the system may not request that the traveler provide payment, but the system can charge the traveler automatically.

The system can determine a travel plan of the traveler by receiving a travel itinerary from the travel. As an alternative, the system can access a calendar of the traveler to retrieve details on the travel plan of the traveler or automatically update the calendar with travel booking details. The traveler can provide the system access to the calendar of the traveler by directing the system a meeting invitation.

The present disclosure provides methods and systems for booking that can involve one or more steps (or involvement steps) from the traveler. In some examples, a traveler is able to book a travel in at most 1, 2, 3, 4, 5, 6, 7, 8, 9, or 10 steps. As an alternative, the traveler is able to book a travel in at least about 0, 1, 2, 3, 4, 5, 6, 7, 8, 9, or 10 steps. For example, the system can book travel options for the traveler with a single authorization step from the traveler (“Book it?”) or without any involvement from the traveler (i.e., 0 steps).

Systems of the present disclosure can be programmed or otherwise configured for proactive travel booking. In some situations, the system detects a traveler's need to travel in a number of ways and automatically offers the traveler booking options. This can be done either directly by the system or through other third parties or third party software (e.g., calendar, email, virtual assistant application and to-do lists), such as partners of the system. In some examples, the traveler provides the system access rights to the traveler's calendar (e.g., Outlook® calendar or Google® calendar), which enables the system to view the calendar of the traveler. The system accesses the calendar of the traveler and detects upcoming meetings (dates, times and locations), which may be in other cities. The system then determines that the traveler may need to travel from the present location of the traveler to the destination of a given meeting. The system then makes traveler arrangements for the traveler, in some cases without any involvement from the traveler. However, the system may request that the traveler authorize the traveler to make a given arrangement. Such authorization may be provided through an electronic message (e.g., email or text message).

In some situations, the traveler gives the system access to the traveler's email and the system detects text in the email of the traveler that that indicates that the traveler is planning on traveling. The email may include text that is indicative of a date, time, departure location and destination location of the traveler. The email can be, for example, a flight booking confirmation. In such a case, the system can offer the traveler a hotel and rental car, as well as other travel and booking options.

As an alternative, or in addition to, a traveler can grant a third party (e.g., distribution partner) access to either a calendar or email(s) of the traveler. The third party can then detect the need for travel (as described above) and offer travel booking options to the traveler. Such booking options can be, for example, offered directly on a travel app on a mobile electronic device of the traveler, which mobile electronic device is in communication with the system. The system can then finalize the booking.

In an example, a traveler using a “To Do List” application indicates the need to book travel. The application may be installed on an electronic device of the traveler that is in communication with a system that is programmed to facilitate the booking of travel arrangements. The system, through the application (e.g., through an application programming interface), can offer the traveler booking options. In some cases, additional questions can be directed by the system to the traveler in order to determine travel dates or other attributes about the trip. Such questions may be asked as part of the booking process.

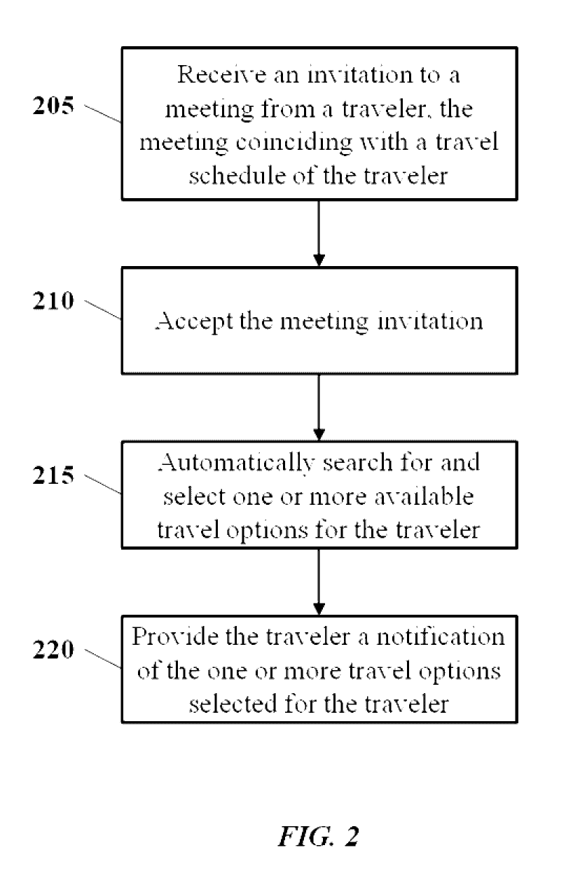

FIG. 2 shows a method for making travel arrangements for a traveler. In a first operation 205, the system receives an invitation to a meeting from the traveler. The meeting can coincide with a travel schedule of the traveler. Next, in a second operation 210, the system accepts the invitation. In a third operation 215, the system searches for and selects one or more available travel options for the traveler. In some cases, the system searches for and selects one or more available travel options with any involvement from the traveler. Next, in a fourth operation 220, the system provides the traveler a notification of the one or more travel options selected for the traveler.

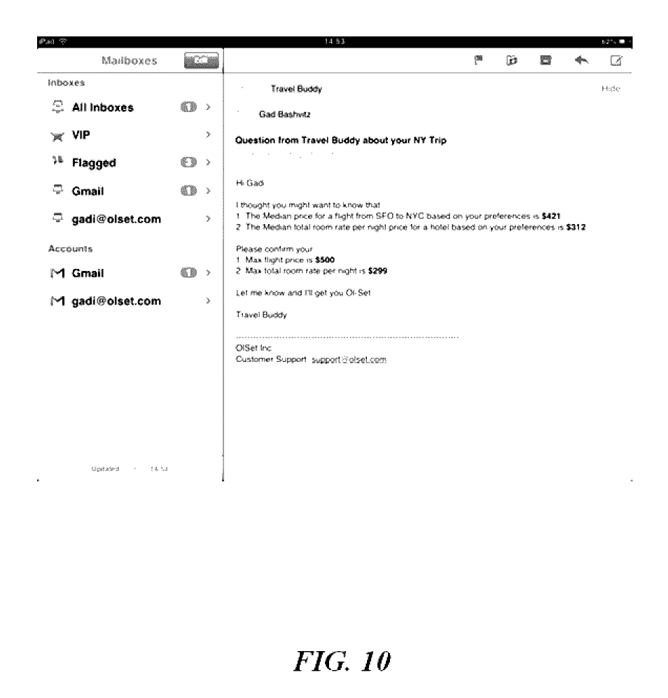

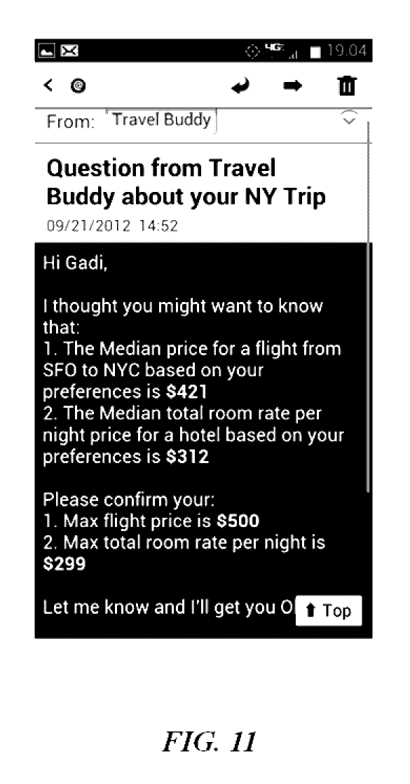

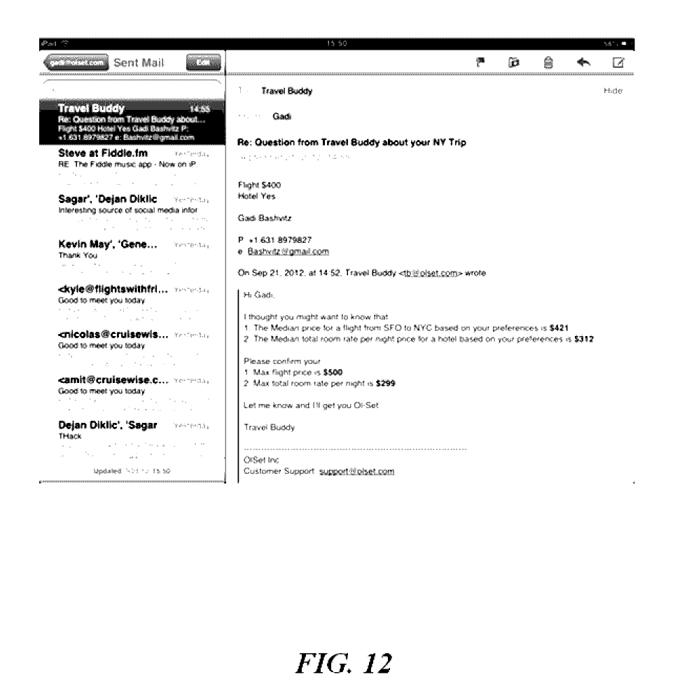

In some examples, between operations 210 and 215 the system can verify options and/or preferences, and/or request additional information from the traveler. For example, the system can inform the traveler as to the average price for a hotel or a flight (see, e.g., FIG. 10), and request that the traveler confirm trip details. The system can then receive from the traveler confirmation of trip details or the amount of money the traveler would prefer to pay, and provide the traveler the opportunity to change the traveler's preferences (see, e.g., FIG. 12).

In an example, the traveler (or a system of the traveler) provides the system an invitation to an electronic meeting on a calendar of the traveler, such as a Microsoft® Outlook®, Yahoo® calendar, Apple iCal® calendar, or Google® calendar. The invitation can include travel criteria of the traveler, such as, for example, a travel start time, end time, start location and end location (“travel parameters”). The system accepts the invitation and searches for and selects travel options that are within the travel parameters set forth in the invitation. As such, the traveler is able to direct the system to conduct a search for the traveler, in some cases with minimal involvement by the traveler. This process does not have to be done via the calendar; it can also be completed by sending an email to the system or completing the travel booking request in an application or on a website. The system can also detect meetings in a traveler's calendar or email to automatically offer booking options.

In other cases, travel booking can be triggered within a virtual assistant application (app) based on that app detecting the user's plan to travel. This detection can be done, for example, based on information in the user's calendar, email or to do list. Once this plan to travel is detected, personalized travel options can be offered to the user within the app or through a link or email to a UI, such as a web-based interface (e.g., as may be provided through a web site).

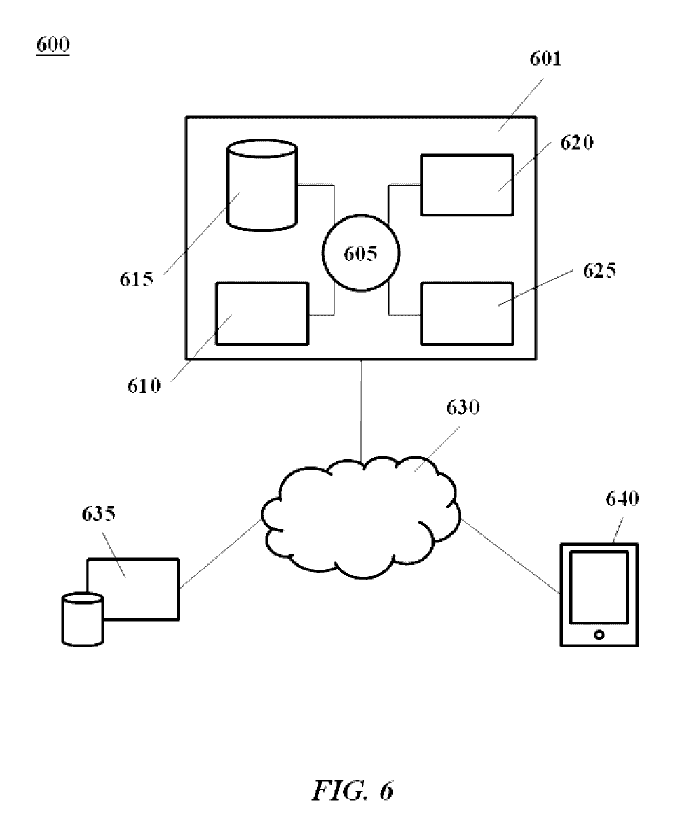

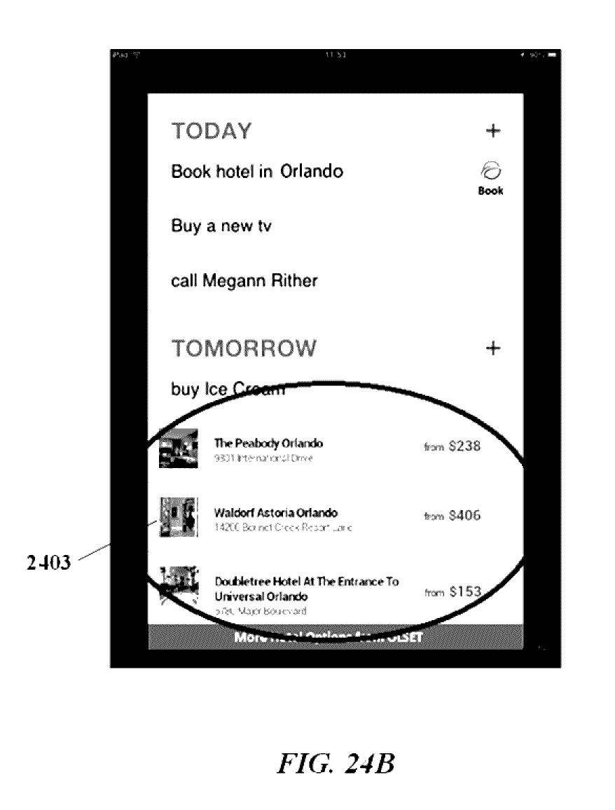

FIGS. 24A and 24B show screenshots from an example method for proactively offering personalized hotel booking options to a user of a virtual assistant application. In FIG. 24A, the user has added a travel-related task 2401 (“Book hotel in Orlando”) within a to-do application of the user, which can be a travel application or other to-do task application that may not be necessarily dedicated to travel. A system that is programmed to facilitate travel booking (e.g., the server 601 of FIG. 6) then detects the user's travel plan in the to-do application and offers travel options in field 2402. The user is able to book the travel options from the application. In FIG. 24B, the system provides the user with other travel options 2403 that may be relevant to the task 2401. In the illustrated example, the other travel options 2403 are hotel options.

If the system determines that the user is travelling, the system can make various travel suggestions and enable the user to book one or more of the travel suggestions. For example, if the system detects that the user is going to be travelling to Orlando, Fla., and the system determines that the user has not yet booked a flight or hotel, the system can suggest hotel and/or flight options and provide the user with the opportunity to book (e.g., single click booking) the hotel and/or flight options. As an alternative, the system can automatically book the hotel and/or flight options for the user. For example, in FIGS. 24A and 24B, the system can enable the user to book a flight from the user's current location to Orlando, Fla., and also enable the user to complete the task 2401 by providing the user with the other travel options 2403 to choose from, which can be, for example, hotel options in Orlando, Fla.

In some embodiments, a traveler workflow can include at least three phases. In a first phase, a database of the system is populated with travel (inventory) options. In a second phase, the traveler is registered with the system and a traveler profile is created. In a third phase, the system searches for and books travel options for the traveler.

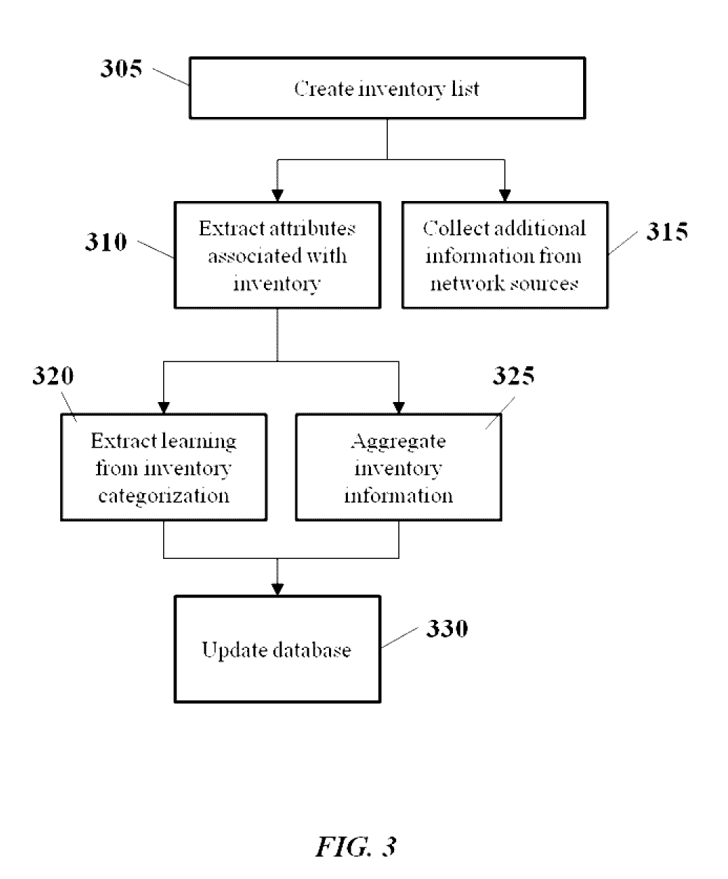

The first phase is illustrated in FIG. 3. In a first operation 305, the system creates an inventory list, which list can include, for example, available hotels. The inventory list can be populated by accessing providers, such as web sites of providers, and retrieving available accommodations. Next, in a second operation 310, the system extracts available attributes and categorizes the inventory based on these attributes. The available attributes can be, for example, address, star rating, amenities and preferred hotel chain. In operation 315, the system collects additional information about the inventory from network sources, such as social media and other available sources (e.g., TripAdvisor®, Facebook®, Twitter®). In operation 320, the system extracts learning from the inventory categorization. This can include knowledge, such as the average price of a high end hotel at a given location during a particular time of year. In operation 325, the system aggregates inventory information from various sources, such as, for example, from social and non-social sources, to create a comprehensive profile for the inventory items. Next, in operation 330, the system updates an inventory database of the system or in communication with the system. The database can be updated with relevant attributes and historical trends for use when a traveler goes through the booking process. The system can select from available travel options from a database created by the system. The system can be as described elsewhere herein (see, e.g., FIG. 6).

In some situations, categorizing hotel and flight inventory may be based on attributes so that the system can match traveler preferences to the available inventory. The system in some cases may start with hotel inventory and later expand to other inventory, such as, for example, flights, car rentals, activities, restaurants and transportation. The system can use at least two types of inventory: the overall inventory that may be categorized and the available inventory at any given point in time. While a hotel may exist, it may not be available at a given point in time.

The system can collect hotel attributes in a number of ways. The system can collect inventory information about hotels from an online travel agency (OTA) or multiple OTA's, from the hotel website or from other sources. Attributes that the system can collect about inventory include: price band (i.e., whether the hotel typically fall into a specific price band, such as, e.g., expensive or cheap), the star rating of the hotel, customer reviews (e.g., Yelp® reviews, Hotel.com® reviews), amenities, hotel chain, type(s) of room (e.g., smoking or non-smoking), bed sizes, type of hotel (e.g., business, vacation, family), whether hotel price fluctuates throughout the year, whether there are preferable days and times to book the hotel, points of interest in proximity to the hotel, whether the hotel is at a location that may be considered of interest to travelers (e.g., hotel is in the center of town).

As an alternative, the system can collect indirect information and inferred information about the hotel. Indirect information can include travelers who post information on either review sites, hotel information on network web sites (e.g., Facebook®, Twitter®, Google+®), current information about hotel amenities. The system can monitor activity on a social media web site for information that may be relevant to the hotel. Inferred information can include grouping hotels into clusters based on their attributes, and using cluster analysis to infer an attribute of a given hotel based on attributes of the cluster. This can preclude the need to collected detailed information about every hotel in the cluster. Cluster analysis can show which attributes show up most often and which preference combinations are most common. In some cases, the system identifies the common preference groups and determines if it makes sense to tag a given group as a distinct group. The system can then assign a hotel to the group.

The system can collect hotel inventory information by continuous discovery and learning. The system can continuously update the database of the system with hotel information by periodically sampling OTA data or other sources of data and detecting a change with respect to information available in the database. In some cases, the system updates indirect information from social media providers or other network providers to identify information that is otherwise not available. Once the system collects this information, the system can perform an analysis on attributes, which may enable the system to filter attributes to optimize the hotel recommendation process.

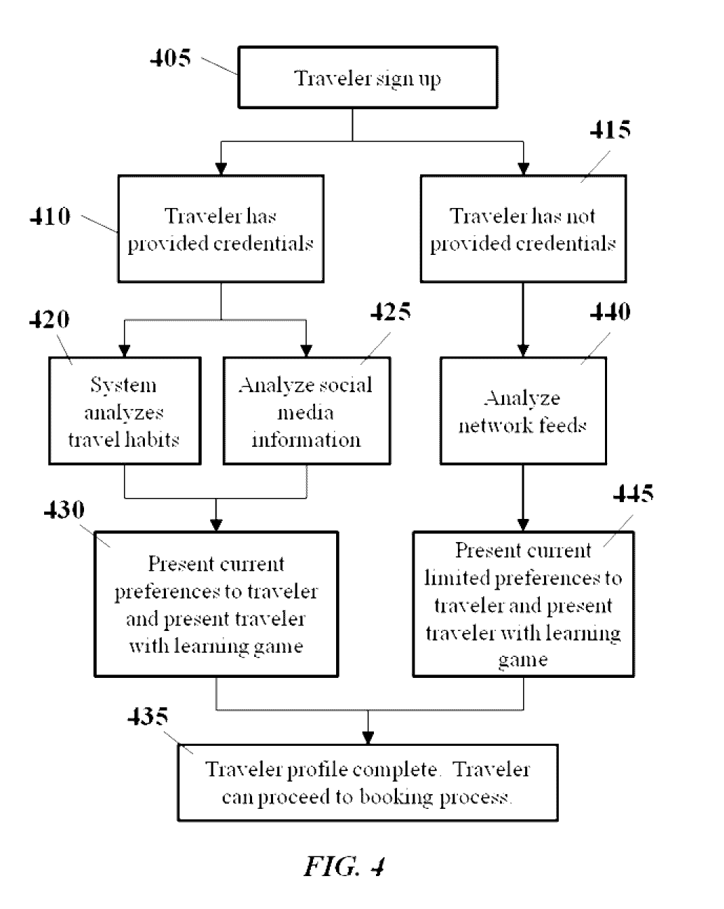

In another phase of the booking process, the system registers the traveler with the system. With reference to FIG. 4, in a first operation 405, the traveler is registered into the system. In some examples, the traveler can register (or sign into) the system using a network profile of the traveler, such as a social medial network profile (e.g., Facebook® profile, Google+® profile, LinkedIn® profile). The travel can provide online travel agency (OTA) credential (e.g., TripIt®, Priceline® credential or Expedia® credential). Next, the system determines whether the traveler has provided credentials (e.g., log-in information) 410 or not provided credentials 415. If the traveler has provided credentials (410), then in operation 420 the system analyzes the travel habits of the traveler, and in operation 425 the system analyzes social media information of the traveler. In operation 420 the system can analyze the traveler's past travel habits, extract preferences and categorize the traveler into a traveler group. In operation 425 the system can analyze the traveler's social media feeds (e.g., Facebook® feeds, Twitter® feeds), and augment the traveler's preferences using information collected or otherwise gleaned from the social media feeds.

Next, in operation 430 the system presents current preferences to the traveler and takes the traveler through a learning game to further establish preferences for the travel and calibrate a sensitivity of the system with respect to travel options. The system then completes the registration process and provides the traveler personal information (e.g., login information, account information). At operation 435, the traveler profile is deemed complete, and the traveler can proceed to the booking process.

The learning game can be a machine learning game in which the system asks the traveler questions to better understand the traveler's likes and dislikes. The learning game can include at least 1, 2, 3, 4, 5, 6, 7, 8, 9, 10, 20, 30, 40, 50, 100, or 500 questions, and can present such questions to the traveler in textual, audio and/or video format. The questions can each include responses for the traveler. The questions can be presented to the traveler as part of a questionnaire in which the system presents the traveler a question that is intended to elicit a response from the traveler. The learning game can be part of a learning engine of the system, which can employ one or more machine learning algorithms to assess the traveler's preferences. The learning engine can be used to train the system to the traveler's likes and dislikes, and travel and accommodation preferences. The learning engine can enable the system to predict a traveler's likes and dislikes, and travel and accommodation preferences with minimal, and in some cases no involvement from the traveler following training of the system.

As an alternative, if, at operation 415, the traveler has not provided the system with credentials, then at operation 440 the system can analyze network feeds for information related to the traveler. The system can analyze the traveler's social media feeds (e.g., Facebook® feeds, Twitter® feeds), and augment the traveler's preferences using information collected or otherwise gleaned from the social media feeds. The preferences in such a case can be baseline or default preferences, which can be augmented with information that has been collected from the social media feeds. Next, at operation 445 the system presents the traveler with current limited preferences and takes the traveler through the learning game to aid in developing the preferences of the traveler and the sensitivity of the system to travel options. The system then completes the sign-up process and provides the traveler personal information. Next, at operation 435, the traveler profile is deemed complete, and the traveler can proceed to the booking process.

The system can collect and understand a traveler's preferences, such as the traveler's hotel preferences, travel preferences, food and/or beverage preferences, and other preferences of or related to travel, including staying at a given location for a finite period of time, such as car rentals, activities, restaurants and ground transportation. The system can collect information by direction collection, indirect collection and inferred collection. The system can verify information and conduct sensitivity analysis, and perform continuous discovery and learning as to traveler information, including traveler preferences.

Direct collection can include an assessment of a traveler's previous trip selection preferences. Direct collection can include contacting a traveler's OTA and retrieving information on a traveler's travel history, including travel preferences (e.g., seat selection, type of flight, time and day of flight, seat preferences, ground transportation preferences, and food preferences). Under direct collection the system can determine whether there is a price band (i.e., whether the traveler typically selects top priced hotels, low priced hotels), whether there is a pattern as to star ratings, customer reviews, amenities, hotel chain, type of room, who the traveler travels with, length of trip, departure locations and destination location. There may also be a pattern for different kinds of trips like family trips versus business trips. In addition, the type of preferred OTA may be an indication of preferences. For example, if a traveler typically uses a given OTA (e.g., Hotwire®, Priceline®), then the system can learn that the traveler has a higher sensitivity to price than other attributes.

In some cases, collecting this information may enable the system to generate an assessment of the travel preferences of a traveler without relying on the traveler to manually provide this information. In order to collect this information, the system may need to log in to one or more OTA's of the traveler or import travel preference information for use. In some cases the traveler may not use an OTA but may book directly with an airline or a hotel, which may, in itself, provide an indication of traveler preferences of the traveler. Some of the information collected is amenity and service sentiment in order to enable the automated booking process and provide travelers with the information they may need to make an informed decision. The system can categorize traveler reviews of hotels and extracted sentiments that travelers have expressed about hotel amenities or service elements. These can include reviews and/or sentiments with respect to, for example, the quality of the swimming pool or internet, the friendliness of staff, quality of bathroom, etc. The system can then use these sentiment elements to better match a booking for travelers.

Indirect information can be collected from network sources, such as social media sources. Network information may be used to assess, for example, the type of hotel(s) the traveler likes or dislikes. The system may obtain a dataset from network sites (e.g., TripAdvisor®, or Yelp®) to glean information as to the preferences of the traveler. The system can determine if there is a pattern about specific preferences that a traveler shares about travel preferences of the traveler (e.g., amenities, sports teams, or cuisine types liked or disliked by the traveler). The system can also determine if the traveler has indicated any trusted or preferred travel friends or companions and collect traveler preferences based on these preferred travel friends' preferences. Such indirect information can be obtained from network sources, such as, for example, social media providers (e.g., Facebook®, Twitter®, Google+®).

In some cases, in order to collect indirect information, the system may need to get traveler login credentials for their social information or get their handles and approval to use the information. The system may assume that travelers may log into the system using a social media login of the traveler (e.g., Facebook® login, LinkedIn® login, Google+® login, Twitter® login), which can enable the system to collect traveler preference information from a social media account of the traveler.

The system can infer a traveler's travel preferences from third parties (e.g., friends, companions, acquaintances). For instance, the system can glean a traveler's likes and dislikes from social media posts of a friend of the traveler. In some cases, once the system has collected a traveler's direct and indirect preferences, the system can categorize or cluster them into traveler groups. If the system has placed a requisite number of travelers in a group, the system can infer preference information about a traveler based on an average behavior of the group. For instance, if the system has placed the traveler in a given group that prefers first class seating, the system can infer that the traveler may have other preferences (e.g., private shuttle service) that are in-line with what the system deems to be average group attributes.

In some cases, once the system has collected direct and indirect information about who travelers travel with, the system can associated travelers together and infer preferences for a traveler based on people they travel with. This can also provide the system the ability to determine a trusted friend or companion of the traveler, which may permit the system to associate travelers into groups (there is marketing value to this as well). This may provide various marketing options for third parties.

In some situations, the system can perform cluster analysis to determine what preferences show up most often and which preference combinations are most common. Once the system has identified a common preference group, the system can determine if it makes sense to tag or otherwise indicate a group as a distinct group. This may permit the system to assign the traveler a travel companion (e.g., travel buddy) to the group and use this for trust and marketing services, for example.

The system may conduct verification and sensitivity analysis. For instance, once the system has collected traveler preferences based on direct collection, indirect collection, and/or inferred collection, the system can present preferences to the traveler and let them make changes if needed so that the system can use the traveler's their input as part of the profile creation process. The system can ask the traveler additional information or guide the traveler through a game or questionnaire to obtain additional information about traveler preferences of the traveler and gauge a sensitivity of the traveler to different preferences. For example, this can permit the system to determine or better assess a traveler's sensitivity to price and distance. In some situations, price may be more important to the traveler than distance, or vice versa. The learning process can enable the system to learn the traveler's sensitivity between multiple preferences, such as, e.g., that a traveler is willing to pay an additional $10 for every 0.3 miles the hotel is closer to their meeting location.

The system can conduct continuous discovery and learning. As a traveler books with the system, the system can collect feedback from the traveler and refine or update the traveler preferences of the traveler. The system can also optimize the manner in which the system interacts with them throughout the booking process. This may involve the system asking the traveler questions, such as questions targeted towards the manner in which the system interacts with the traveler. The system can use questions to verify assumptions that the system may make about the traveler. As an example, if a traveler wants to book a hotel room for less than $200 a night but the hotel that is the best match for their preferences costs $215 a night, the system can assume that the traveler may want the hotel room at the elevated price but verify its assumption with the traveler. This can permit the system to verify a booking option prior to selecting the booking option.

The system can provide the traveler a summary of travel preferences of the traveler. The summary may be updated as the system better understands the travel preferences of the traveler, or as the travel preferences of the traveler change.

In an example, the traveler signs in with a social media login of the traveler and provides the system preferred OTA login details of the traveler. Next, the system analyzes previous booking details of the traveler and social information of the traveler, and assigns the traveler to a social group and infers additional information about the traveler. The system then presents traveler preferences to the traveler and directs the traveler through a direct learning process.

In some situations, the system infers initial traveler preferences from category information (e.g., information assessed from one or more network sources, such as social media sources), and obtains additional preference information through direction information and indirect information. This may include directing the traveler through a guided questionnaire, which can be a visual questioner, to gain additional information about the traveler and to test any assumptions the system may have made about the traveler.

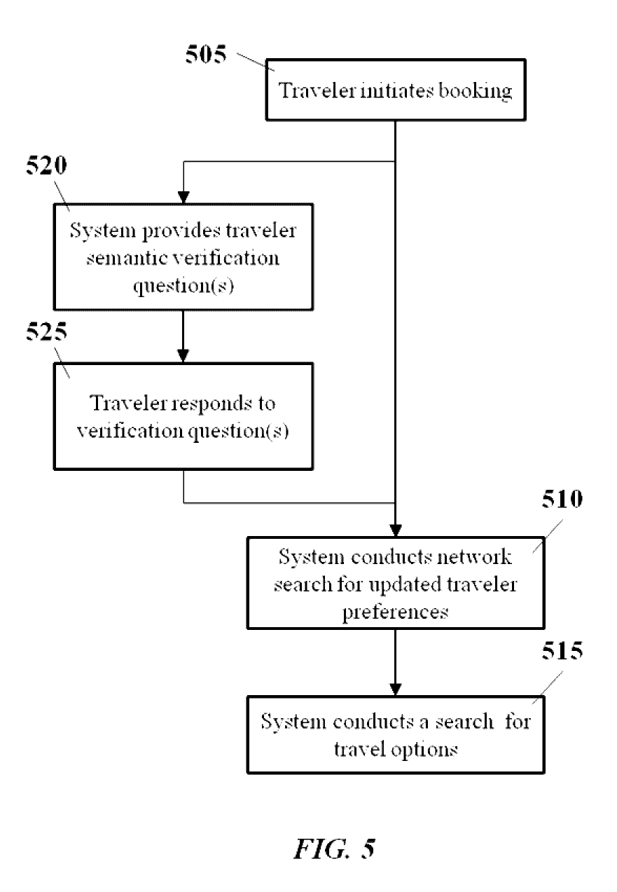

In another phase of the booking process, the traveler initiates a booking request, which can involve the system conducting a search for travel options. The booking request can be initiated using a meeting invite, email, speech enabled booking, or using an application or web site coupled to the system. With reference to FIG. 5, in a first operation 505 the traveler initiates the booking process. In a second operation 510, the system conducts a network search for updated traveler preferences. In an example, the system conducts a social media search (e.g., Facebook® search, Google+® search) to see if there are any new or updated traveler preferences that may need to be considered by the system in conducting a search for travel options. Next, in operation 515 the system conducts a search for travel options using the traveler's preferences. The search can be directed to travel options in a database of the system, which may be populated and/or updated as described elsewhere herein (see, e.g., FIG. 3). Next, the system can present travel options to the traveler or automatically book travel options.

In some cases, in operation 520, upon request by the user to conduct a search for travel options, the system provides the traveler one or more semantic verification questions. The one or more semantic verification questions can provide insight about the trip and ask the traveler for confirmation about one or more booking criteria of the traveler. For example, based on the travel options available the system may determine what a travel option does not meet a travel preference of the traveler, such as maximum price range for a flight. The semantic verification question may ask whether the traveler would find the price increase acceptable. In operation 525, the traveler responds to each of the one or more semantic verification questions. The system then proceeds to operation 510 to conduct a network search for any updated traveler preferences.

In some cases, the system confirms a booking request from the traveler. This may be due to the nature of some speech interfaces being unstructured. After the traveler initiates a booking request, the traveler may receive and email or other communication from the system with all of the requested travel details and may need to confirm some or all of the details, or update the request. The system can then proceed to search for and book travel options for the traveler.

In some cases, after the system books one or more travel options for the traveler and the traveler checks into a given travel option among those booked for the traveler, the system requests feedback from the traveler. The feedback may be intended to gauge the traveler's satisfaction with the travel option, such as satisfaction with a hotel. The feedback may be requested within at least about 1 minute, 2 minutes, 3 minutes, 4 minutes, 5 minutes, 10 minutes, 30 minutes, 1 hour, 2 hours, 3 hours, 4 hours, 5 hours, 6 hours, 12 hours, 1 day, 2 days, 3 days, 4 days, 5 days, 6 days, 1 week, 2 weeks, 3 weeks, or 1 month after the traveler checks into the travel option. The profile of the traveler, including the traveler's travel preferences, may be updated based on the feedback received from the system. Such feedback process may be part of a machine learning engine of the system, which may enable the system to better adapt to the traveler.

### Systems for Booking Travel Options

Another aspect of the invention provides systems programmed to implement methods of the disclosure. FIG. 6 shows an example system 600 adapted to automatically make travel arrangements for a traveler, in accordance with an embodiment of the invention. The system 600 includes a central computer server (“server”) 601 that is programmed to implement methods of the disclosure. The server 601 includes a central processing unit (CPU, also “processor” and “computer processor” herein) 605, which can be a single core or multi core processor, or a plurality of processors, such as for parallel processing. The server 601 also includes memory 610 (e.g., random-access memory, read-only memory, flash memory), electronic storage unit 615 (e.g., hard disk), communications interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communications bus (solid lines), such as a motherboard. The storage unit 615 can be a data storage unit (or data repository) for storing data. The server 601 can be operatively coupled to a computer network (“network”) 630 with the aid of the communications interface 620.

The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630 in some cases, with the aid of the server 601, can implement a peer-to-peer network, which may enable devices coupled to the server 601 to behave as a client or a server.

The storage unit 615 can store files, such as filed related to traveler profiles and/or accounts, and service provider (e.g., airlines, hotels) profiles. The server 601 in some cases can include one or more additional data storage units that are external to the server 601, such as located on a remote server that is in communication with the server 601 through an intranet or the Internet.

The storage unit 615 can store user travel information, including past travel information, current travel information and future travel information. The storage unit 615 can store information of or related to a traveler, such as the traveler's travel preferences, including the traveler's likes and dislikes with respect to travel options (e.g., favorite hotel, favorite airline, preferred food, preferred flight times).

The storage unit 615 can store traveler and service provider data that has been aggregated by the server 601 from one or more sources, such as network sources. The sources can include social media web sites (e.g., Facebook®, Foursquare®, Google+®, Linkedin®, Instagram®), and content that may be available on the Internet, as may be retrieved with the aid of search engines (e.g., Google®, Yahoo®, Microsoft® Bing).

The server 601 can communicate with one or more remote computer systems through the network 630. In the illustrated example, the server 601 is in communication with a first computer system 635 and a second computer system 640 that are located remotely with respect to the server 601. The first computer system 635 can include a database for recording traveler travel information, and the second computer system 640 can be a computer system of a traveler. In some situations, the second computer system 640 may not be part of the system 600, but may be configured to interact with the system 600. However, in situations in which the second computer system 640 is a remote terminal, such as a remote administration terminal, the second computer system 640 may be part of the system 600. The first computer system 635 and second computer system 640 can be, for example, personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants.

In an example, the second computer system 640 is a portable electronic device of a user (e.g., traveler) that wishes to have the server 601 automatically make travel arrangements for the user. The server 601 can conduct a search for travel options and select one or more options that meet travel criteria of the user, and provide the second computer system 640 of the user a travel itinerary or plan. The search results can be displayed on a graphical user interface of the second computer system 640.

In some situations the system 600 includes a single server 601. In other situations, the system 600 includes multiple servers in communication with one another through an intranet and/or the Internet.

The server 601 can be adapted to store user profile information, such as, for example, a name, physical address, email address, telephone number, instant messaging (IM) handle, educational information, work information, social likes and/or dislikes, travel likes and/or dislikes, service provider (e.g., airline, hotel) preferences, restaurant preferences, and historical information of past travel of the user (which may include travel booked by the system 600), and other information of potential relevance to the user or other users. Such profile information can be stored on the storage unit 615 of the server 601.

Methods as described herein can be implemented by way of machine (or computer processor) executable code (or software) stored on an electronic storage location of the server 601, such as, for example, on the memory 610 or electronic storage unit 615. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610. Alternatively, the code can be executed on the second computer system 640 of the user.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Although the system 600 includes a single server 601, the system 600 can include multiple servers. The servers of the system 600 can be implemented in a distributed computing fashion. In some example, the system 600 can be implemented via cloud computing using one or more servers.

Aspects of the systems and methods provided herein, such as the server 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some cases, the server 601 can be configured for data mining, extract, transform and load (ETL), or spidering (including Web Spidering where the system retrieves data from remote systems over a network and access an Application Programmer Interface or parses the resulting markup) operations, which may permit the system to load information from a raw data source (or mined data) into a data warehouse. The data warehouse may be configured for use with a business intelligence system (e.g., Microstrategy®, Business Objects®). The media file management system can include a data mining module adapted to search for media content in various source locations, such as email accounts and various network sources, such as social networking accounts (e.g., Facebook®, Foursquare®, Google+®, Linkedin®) or on publisher sites, such as, for example, weblogs.

Travel details and other communication to or from the system can be presented to the traveler with the aid of a user interface (UI), such as a graphical user interface (GUI), on an electronic device of the user. The UI, such as GUI, can be provided on a display of an electronic device of the user. The display can be a capacitive or resistive touch display, or a head-mountable display (e.g., Google® Goggles, Google® Glasses). Such displays can be used with other systems and methods of the disclosure.

Methods of the disclosure may be facilitated with the aid of applications (apps) that can be installed on electronic devices of users. An app can include a GUI on a display of the electronic device of the user. The app can be configured to perform certain functions of the system, such as, for example, permitting a traveler to search for travel options.

A UI can be presented on a display of an electronic device of a user. The UI can present one or more travel options, such as flight and hotel options. The options can include attributes, such as, for example, star rating of travel option, user review of the travel option, price of the travel option and distance of the travel option from a geographic location of the traveler.

### Match Scoring

The present disclosure provides matching and scoring algorithms for use in finding and booking travel options. The algorithms can be implemented by way of machine executable code executed by a computer processor of a system of the present disclosure.

A matching and scoring algorithm can use information collected about a traveler's preferences from multiple structured and unstructured sources and information collected about the inventory (e.g., hotels, flights, restaurant bookings, ground transportation, local activities, etc.) to propose travel options to a traveler, such as, for example, a hotel room, flight, restaurant etc. The proposed travel options can be determined by the system to best fit with the traveler's preferences. This can be done by identifying the items that the traveler may be most interested in experiencing and purchasing.

Information about the traveler can be constantly adjusted. The traveler's initial preferences can be set by harvesting information from other websites and/or requesting that the traveler enter direct or indirect information into the system. As the traveler uses the system, the system can observe the traveler's interactions with the product choices or explicit feedback, learn from these observations (machine learning), and adjust the traveler's preferences accordingly over time.

Information about the inventory (hotels, flights, activities, etc.) can be collected from information obtained via a live network application programming interface (API), review web sites (e.g., TripAdvisor®, Yelp® or Facebook®), data scraping, or local cached copies of these web sites. This information can include static details about the product: ratings, features, amenities, information processed from customer review sites, traveler sentiment and time sensitive data including: dynamic pricing, availability of inventory, etc.

The information about the product and the traveler can fed into a matching and scoring subsystem (or module) of the system. This subsystem can use filtering to create an initial list of inventory that can match the traveler's base criteria and requests availability from the vendor API's. Further filtering can be performed to remove any product which does not satisfy the traveler's requirements, and scoring/ranking can be performed on the products which pass these filters.

The system can include a scoring subsystem and matching subsystem. The scoring subsystem can compute numeric values on multiple aspects of the inventory attributes and traveler preferences. These component scores can then be combined into a single overall score, and the product with the highest overall score can be presented to the traveler for purchase.

The overall score can be computed from individual normalized component scores on these matching aspects of the inventory and traveler preferences. The scoring subsystem combines some component scores using mathematical summation and others using multiplication.

$$score = \frac{{\sum }_{n = 1}^{N} {w}_{{s}_{n}} {\hat{s}}_{{s}_{n}}}{{\sum }_{n = 1}^{N} {w}_{{s}_{n}}} \frac{{\prod }_{m = 1}^{M} {w}_{{ρ}_{m}} {\hat{s}}_{{ρ}_{m}}}{{\prod }_{m = 1}^{m} {w}_{{ρ}_{m}}}$$

In an example, the subsystem sums the normalized component scores (Ŝₛₙ), applies component weighting (Wₛₙ), and normalizes the overall sum. For hotels, it may score the hotel star rating, traveler review rating, distance of the hotel from a geographic location of the traveler, and price. Then, the subsystem multiplies the normalized component scores (Ŝₚₘ), applies component weighting (Wₚₘ), and normalizes the overall inventory. For hotels, it may score the hotel loyalty program, amenity and amenity sentiment in this fashion. The results of the summation and multiplication scoring can be multiplied together to yield the overall score. If a component weight is absent, the subsystem can ignore this component score when normalizing and computing the overall score.

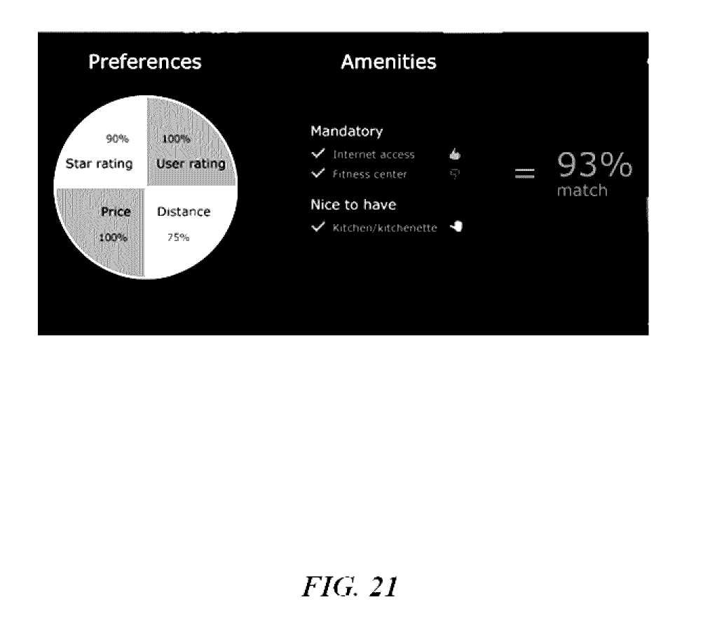

In some examples, the overall score can range between 0.0 and a number just slightly larger than 1.00. This number can be communicated to the user as a match between 0-100%. A score of 100% can indicate all of the traveler's requirements have been met and that this product is a great match for the traveler. FIG. 21 is an example depiction of the matching algorithm to traveler preferences.

### EXAMPLE 1

In an example process for booking travel options, the traveler creates a meeting invite with travel details. The traveler then receives a confirmation question from the system and responds to the confirmation question. The system then provides the traveler a confirmation that the travel option(s) selected for the traveler have been booked. The traveler then reviews the confirmation and the booking details are added to the traveler's meeting invite in their calendar.

In some cases, the system is speech-enabled, in which case the traveler can provide a request for travel options by making a verbal request with the system.

### EXAMPLE 2

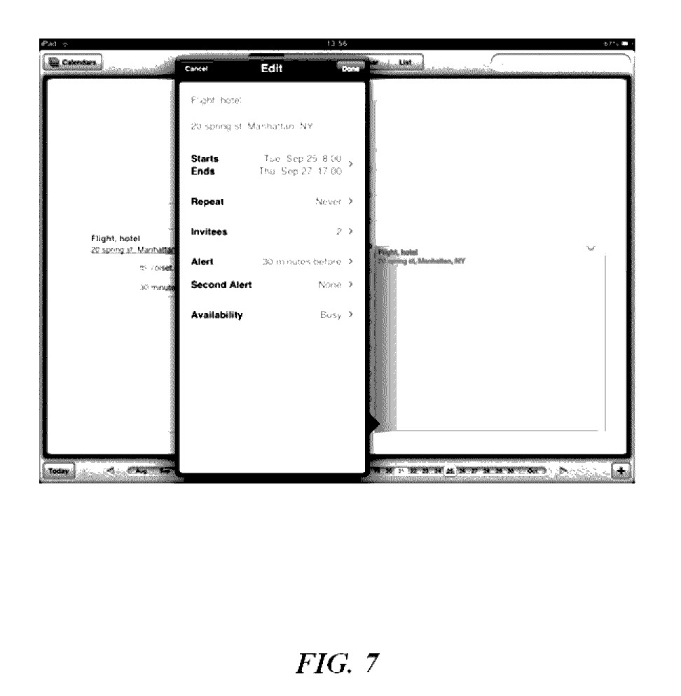

FIGS. 7-21 show example screenshots as may be implemented on a graphical user interface (GUI) of an electronic device of a traveler, each of which may be in communication with a system programmed to facilitate travel and accommodation booking, such as the system 600 of FIG. 6.

In an example automated booking process flow, a traveler creates a meeting invitation (“invite”) with the following details (FIG. 7):

Title: Flight and hotel

Location: 20 Spring street, Manhattan, N.Y.

Starts: Next Tuesday 8 AM

Ends: Next Thursday 5 PM

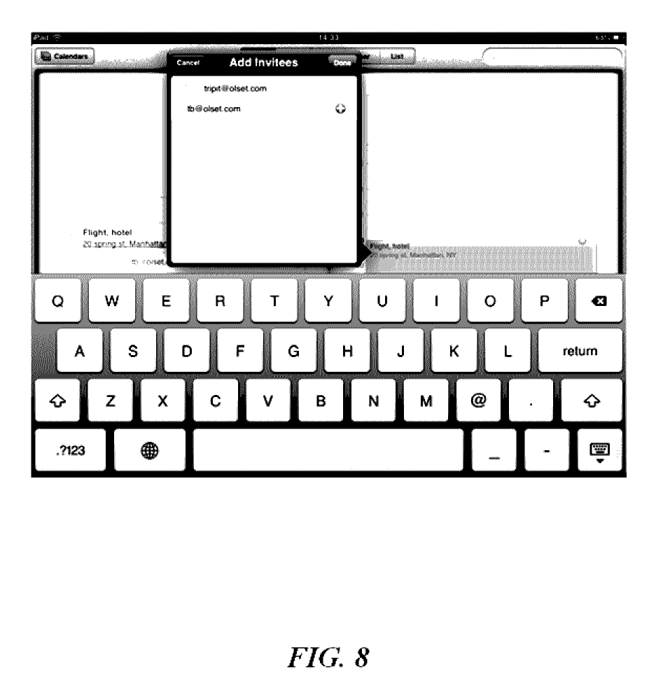

With reference to FIG. 8, the traveler invites the system (travelbuddy@OLSET.com) and Tripit (tripit@OLSET.com) to the meeting.

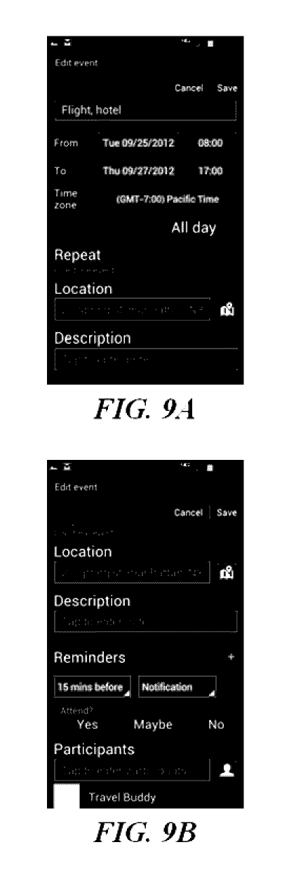

FIGS. 7 and 8 are screenshots of a graphical user interface (GUI) that may be implemented on a personal computer (PC), such as a laptop PC or a tablet PC. FIGS. 9A and 9B shows GUI's that may be implemented using an app on a Smart phone (e.g., Apple® iPhone, Android® enabled telephone). In FIG. 9A, the traveler has inputted the details above, and in FIG. 9B the traveler has added the system (“Travel Buddy”) to the list of participants of the meeting, which can be provided a meeting invitation.

With reference to FIG. 10, after a meeting invitation is sent, the traveler receives an email from the server providing information about the trip and asks the traveler for confirmation about the following booking boundaries: Median flight price based on your preferences is $421; median total hotel nightly price based on your preference is $312. The email also asks the traveler to confirm the following: Your maximum (“Max”) flight price is $500; maximum total nightly room rate is $299. FIG. 11 shows a similar electronic communication received on a Smart phone of the traveler.

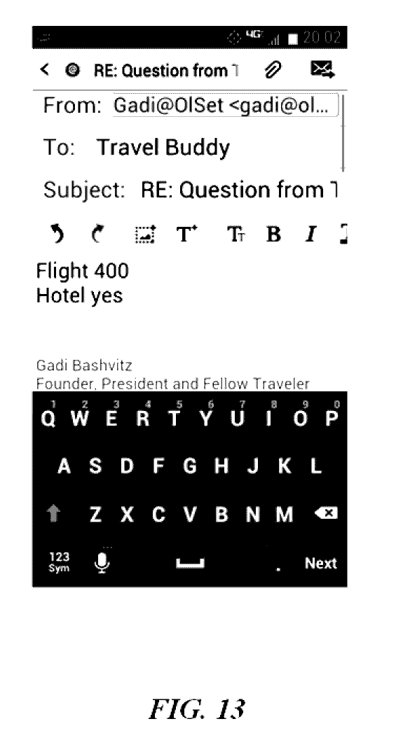

With reference to FIGS. 12 and 13, the system provides the traveler a clarification question (e.g., through an email, text, app or speech interface) stating: Flight $400 (this may change your max booking price for the flight from $500 to $400 for this trip); Hotel Yes (may confirm the $299 a night). FIG. 12 is a GUI that may be displayed on a PC, and FIG. 13 is a GUI that may be displayed on a display of a Smart phone.

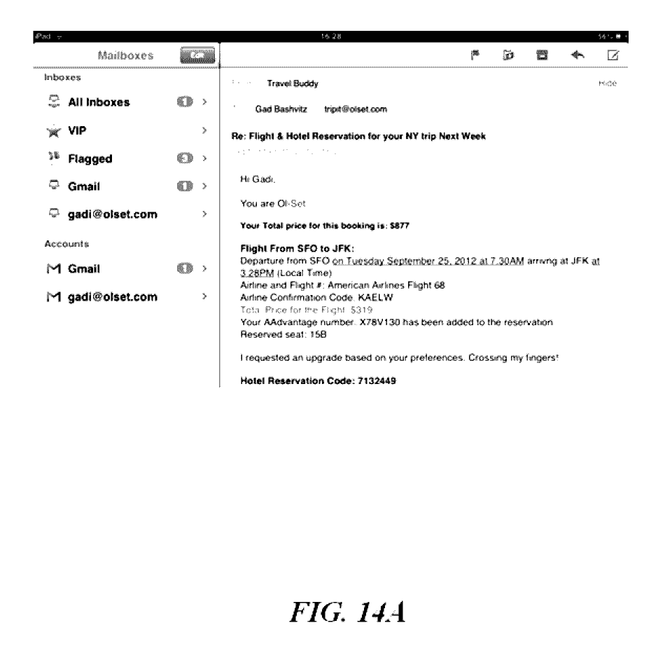

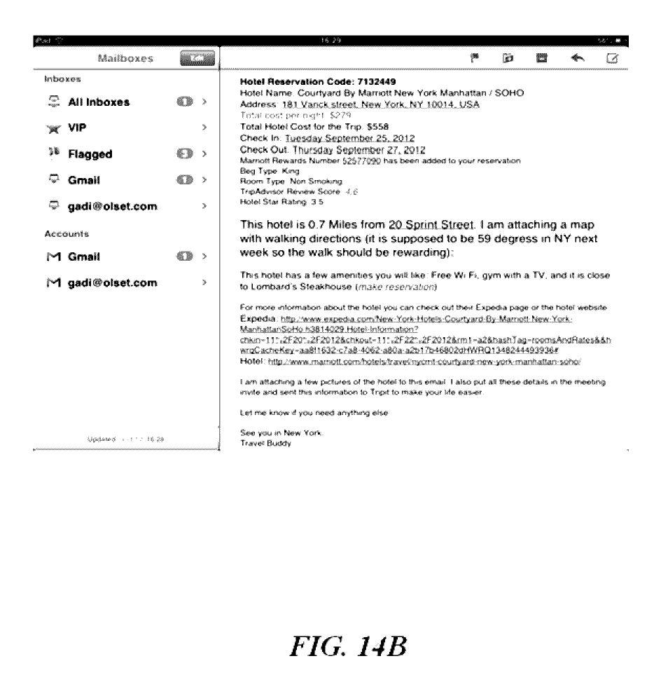

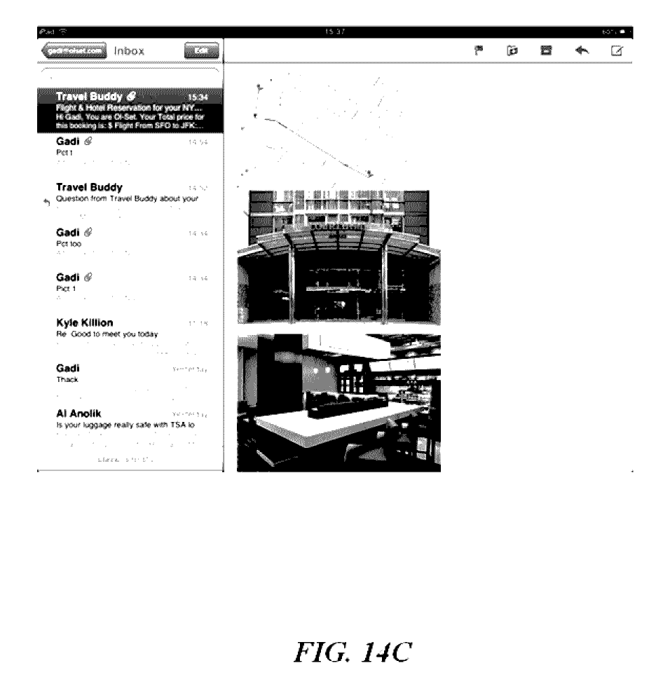

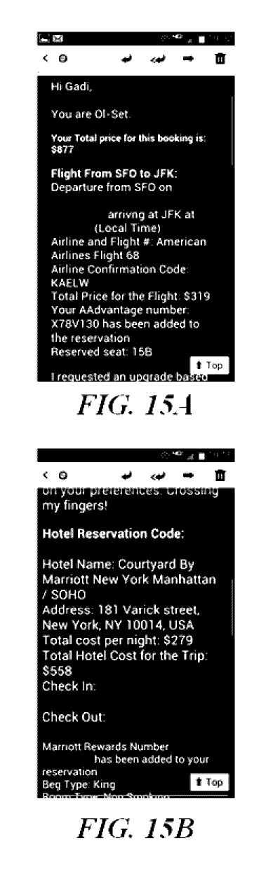

The system may then book travel options for the traveler and provide a confirmation communication (e.g., email, text message, push notification) to the traveler. FIGS. 14A, 14B and 14C show a confirmation email with booked travel options, including flight departure and destination airports, flight day and departure and arrival times, frequent flyer number, total price of the flight, reserved seat, airline, hotel reservation code, hotel name and address, hotel check-in day and time and check-out day and time, a map with directions to the hotel, and pictures of the hotel. FIGS. 15A and 15B show a confirmation screen on a GUI shown on a display of a Smart phone of the user. The system can also provide the traveler points of interest upon travel from one location to another, such as a restaurant or location of social interest to the traveler.

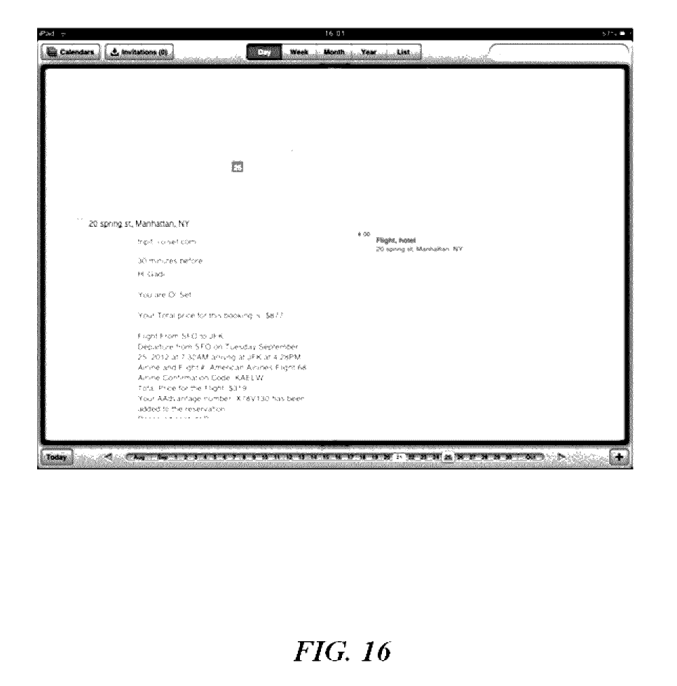

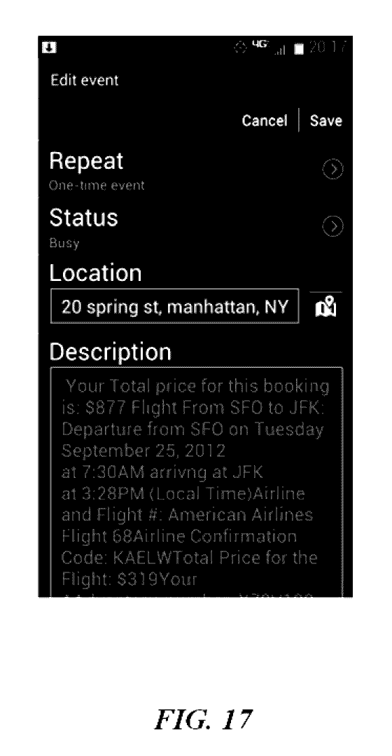

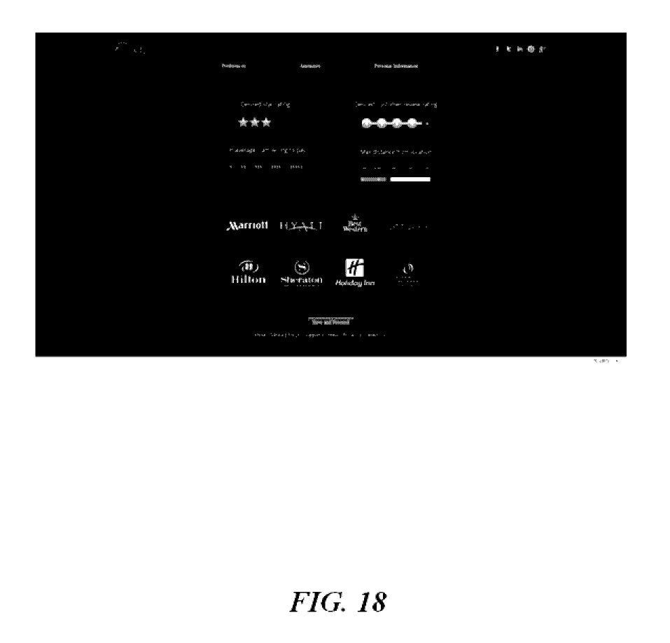

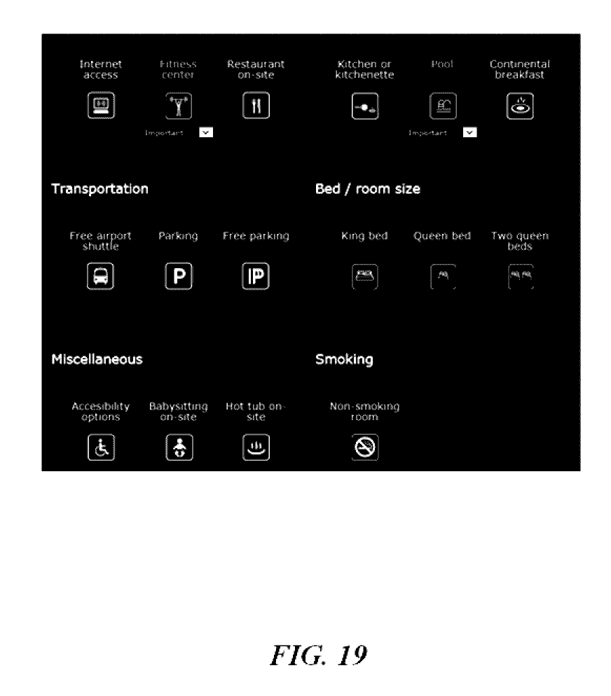

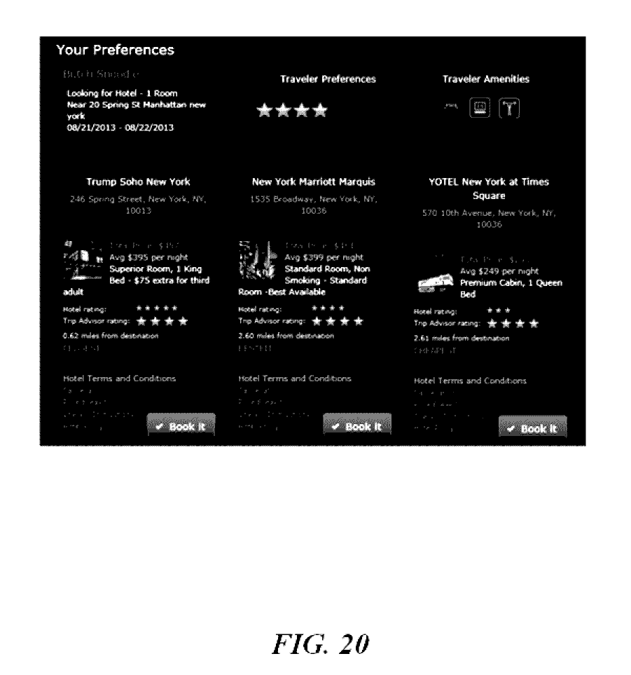

Upon travel confirmation, the system can automatically update a calendar of the traveler with relevant travel details. FIG. 16 shows a calendar of the traveler on a display of a PC of the traveler. FIG. 17 shows a calendar of the traveler on a display of a Smart phone of the traveler. The calendar entries of FIGS. 16 and 17 can include relevant flight and accommodation (e.g., hotel) details. FIG. 18 shows traveler preferences. FIG. 19 provides a sample of amenities that travelers can select as part of their preferences. FIG. 20 depicts three hotel results returned by the system. The GUI of FIG. 20 also provides the traveler the option to book a hotel in a single click (1-click booking). In such a case, the traveler can click on “Book it” and the system can book the hotel without any additional information from or involvement of the traveler. FIG. 21 provides insights into why a specific hotel was selected, including sentiment analysis for each attribute.

### EXAMPLE 3

### Component Scoring for Hotels

### 1. Price

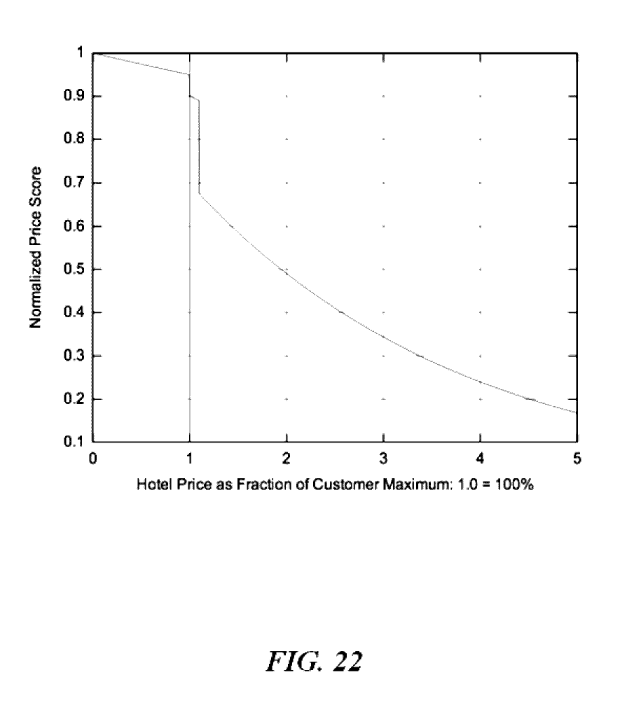

The price component score is computed such that that lower scores are closer to perfect (1.00). The current score function includes two cutoff points, at 100% and 110% of the traveler's maximum price. This creates a discontinuous function. The base function is a constant (0.95) raised to the ratio of the price and maximum prices. Exactly meeting the price cutoff scores 95.0. The maximum price score is 100.0. FIG. 22 shows normalized price score as a function of hotel price as fraction of customer maximum (1.0=100%).

$$score = \{ \begin{matrix}0.95 \frac{price}{{price}_{max}} & for \frac{price}{{price}_{max}} <= 1.0 \\ 0.90 \frac{price}{{price}_{max}} & for \frac{price}{{price}_{max}} <= 1.1 \\ 0.70 \frac{price}{{price}_{max}} & \end{matrix}$$

### 2. Hotel Rating/Hotel Stars

The hotel rating component score is computed such that higher ratings are closer to perfect (1.00). If the hotel exceeds the desired rating, the system can return a score slightly higher than 1.00. Exactly meeting the customer's preference scores 1.00. The maximum score is 100.225, indicating that these hotels are better than the user requested, but that this increase in score may not be significant to the traveler.

$$score = \{ \begin{matrix}100 + 0.05 ( rating - {rating}_{desired} ) & for rating > {rating}_{desired} \\ 100 \frac{rating}{{rating}_{desired}} & \end{matrix}$$

### 3. Traveler Review Ratings

The trip advisor review component score is computed such that higher reviews are closer to perfect (1.00). If the hotel exceeds the desired rating, the system can return a score slightly higher than 1.00. Exactly meeting the customer's preference scores 1.00. The maximum score is 100.225, indicating that these hotels are better than the user requested, but that this increase in score may not be significant to the customer.

$$score = \{ \begin{matrix}100 + 0.05 ( rating - {rating}_{desired} ) & for rating > {rating}_{desired} \\ 100 \frac{rating}{{rating}_{desired}} & \end{matrix}$$

4. Distance from Location

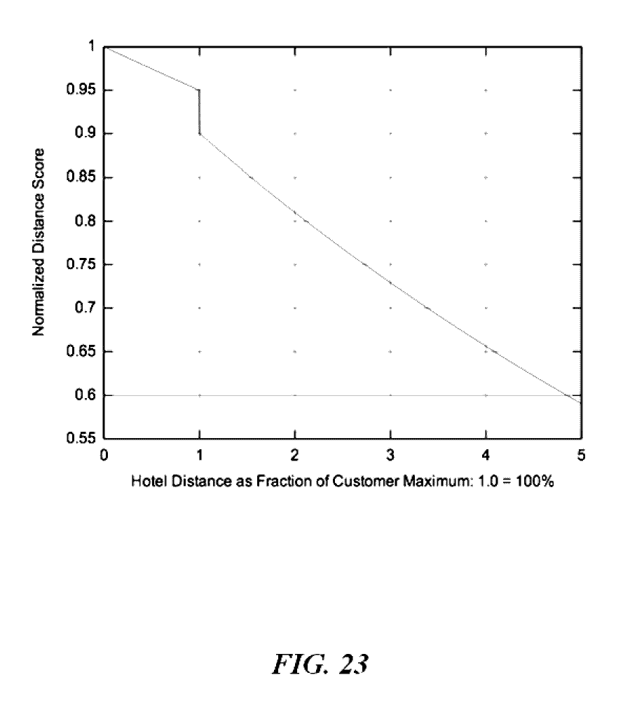

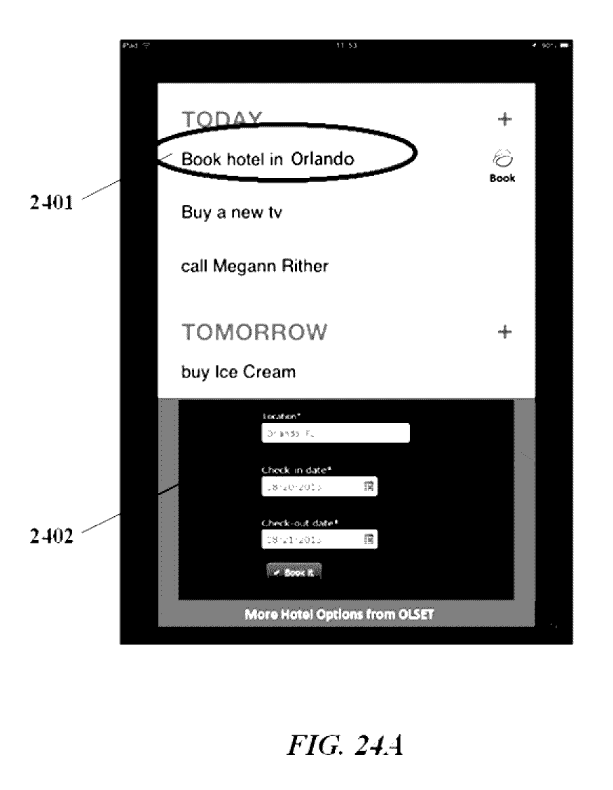

The distance component score is computed such that that lower scores are closer to perfect (1.00). The distance scoring function is similar to the price scoring function, but includes only one discontinuous cutoff at 100% of the traveler's maximum distance. . The base function is a constant (0.95) raised to the ratio of the distance and maximum distance. Exactly meeting the distance cutoff scores 95.0. FIG. 23 shows normalized distance score as a function of hotel distance as fraction of customer maximum (1.0=100%).

$$score = \{ \begin{matrix}0.95 \frac{distance}{{distance}_{max}} & for \frac{distance}{{distance}_{max}} <= 1.0 \\ 0.90 \frac{distance}{{distance}_{max}} & \end{matrix}$$

The distance calculation is based on geographic location lookup using the Google Maps API. The API determines if the search was an exact address or a more broad geographic region. If the traveler is searching through a broad geographic region, it may be beneficial to adjust the distance function or distance cutoff for results that are close to the desired location. This is so that hotels in “San Francisco” aren't unfairly penalized for being far from some arbitrary point defined as the center of San Francisco by Google.

### 5. Loyalty Program

If information has been provided by the traveler identifying one or more hotel chain loyalty programs, the system can assign a weighted multiplier to this hotel score. Currently this weighting is 1.20 if the hotel is a member of the specified loyalty program or 1.00 if no appropriate match can be found. This weighting can be adjusted by the traveler if the traveler assigns an importance to the overall loyalty program boost and the boost for a specific chain's match. This weighting may also be adjusted dynamically as the system learns the traveler's preferences.

### 6. Amenities and Hotel Features

The traveler preferences can contain a list of features and amenities that a hotel may offer and a numeric value indicating the importance the traveler associates with that feature [e.g. Mandatory: 1.0, Important: 0.75, Nice to Have: 0.5, Unimportant/Absent: 0.0]. Additionally, this same list of features and amenities can exist for the hotel being evaluated. The hotel list can be adjusted based on two inputs: vendor supplied information indicating whether the hotel offers this feature or amenity [i.e. 0.0=absent, 1.0=present] and a sentiment value calculated by the system based on categorizing sentiments from traveler reviews collected from multiple data sources [e.g. positive=7.0, neutral=2.0, unknown=1.0, negative=0.5] harvested from reviews or other natural language data sources for this property.

These two lists (a.k.a vectors) can be analyzed for cosine similarity (see below). This analysis can yield a numeric output running from −1.0 to +1.0 with +1.0 indicating an exact match. The output of the cosine similarity can be scaled as (cosine_similarity/4.0+1.0) resulting in a multiplier between 0.75 and 1.25.

In some examples, the cosine of two vectors can be derived by using the Euclidean dot product formula:

a·b=∥a∥∥b∥ cos θ

Given two vectors of attributes, A and B, the cosine similarity, cos(θ), is represented using a dot product and magnitude as

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} .$$

The resulting similarity ranges from −1 meaning exactly opposite, to 1 meaning exactly the same, with 0 usually indicating independence, and in-between values indicating intermediate similarity or dissimilarity.

### 7. Weights

Each component score can have a weight associated with it. These weights can be varied to tune the scoring system. This tuning can be done across all travelers and the default weights for a new traveler can reflect the system wide tuning.

This tuning can also occur as the system observes and learns from the traveler's choices or feedback. Based on these choices or feedback items, the weights for a particular scoring component can be automatically adjusted up or down on a traveler-by-traveler basis. This can result in an individualized matching and scoring result.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A computer-implemented method for making travel arrangements for a user, comprising:
(a) determining a travel schedule of said user;
(b) using a computer processor, conducting a search directed to travel options that coincide with said travel schedule, and storing available travel options in memory;
(c) selecting one or more travel options from said available travel options; and
(d) notifying said user of the one or more travel options selected in (c).

2. The method of claim 1, wherein (d) further comprises directing an electronic communication to said user to notify said user of the one or more travel options selected in (c).

3. The method of claim 2, wherein said electronic communication is an electronic mail.

4. The method of claim 1, wherein in (c), said one or more travel options are selected based upon a comparison of said available travel options to travel preferences of said user in memory operatively coupled to said computer processor.

5. The method of claim 1, wherein said available travel options are weighted by any two attributes selected from star rating, user review, price and distance.

6. The method of claim 1, wherein in (a), said travel schedule is determined by:
accessing an electronic mail account of said user, which electronic mail account comprises one or more electronic mails;
reviewing said one or more electronic mails to identify content that is indicative of said travel schedule; and
determining said travel schedule from said identified content.

7. The method of claim 6, wherein said content is text and/or graphical information.

8. The method of claim 1, wherein in (a), said travel schedule is determined by accessing an electronic calendar of said user and identifying text that is indicative of said travel schedule.

9. The method of claim 8, wherein said text comprises a date and destination location.

10. The method of claim 1, wherein determining the travel schedule of said user comprises:
receiving an invitation to a meeting from said user, wherein said invitation coincides with a travel schedule of said user;
accepting the meeting invitation; and
determining said travel schedule from said meeting invitation.

11. The method of claim 1, wherein said one or more travel options are selected from said available travel options without any involvement from said user.

12. A computer-implemented method for making travel arrangements for a user, comprising:
(a) determining a travel schedule of said user;
(b) using a computer processor, conducting a search directed to travel options that coincide with said travel schedule, and storing available travel options in memory;
(c) presenting one or more travel options from said available travel options to said user; and
(d) receiving the selection of a given travel option from said one or more travel options from said user.

13. The method of claim 12, wherein said available travel options are weighted by any two attributes selected from star rating, user review, price and distance.

14. The method of claim 12, wherein in (a), said travel schedule is determined by:
accessing an electronic mail account of said user, which electronic mail account comprises one or more electronic mails;
reviewing said one or more electronic mails to identify content that is indicative of said travel schedule; and
determining said travel schedule from said identified content.

15. The method of claim 14, wherein said content is text and/or graphical information.

16. The method of claim 12, wherein in (a), said travel schedule is determined by accessing an electronic calendar of said user and identifying text that is indicative of said travel schedule.

17. The method of claim 16, wherein said text comprises a date and destination location.

18. The method of claim 12, wherein determining the travel schedule of said user comprises:
receiving an invitation to a meeting from said user, wherein said invitation coincides with a travel schedule of said user;
accepting the meeting invitation; and
determining said travel schedule from said meeting invitation.

19. The method of claim 12, wherein said one or more travel options are selected from said available travel options without any involvement from said user.

20. The method of claim 12, wherein in (c) said one or more travel options are presented on a user interface (UI) of an electronic device of said user, which UI presents a given travel option and at least two attributes of said travel option selected from star rating, user review, price and distance.

21. A method for prioritizing travel options, comprising:
(a) receiving a request from a user for a travel option, wherein said request comprises a geographic location selected by said user;
(b) using a computer processor, searching a database of travel options for one or more travel options that match said request of (a), which match is based on a comparison between (i) one or more travel option preferences of said user as maintained in a profile of said user, and (ii) a score of a given travel option in said database that is weighted by any two attributes selected from star rating, user review, price and distance from said geographic location; and
(c) based on said search of (b), providing one or more travel options that match said request.

22. The method of claim 20, further comprising receiving a request form a user to book a given travel option among said one or more travel options.

23. The method of claim 20, further comprising booking said given travel option without any additional involvement from said user.

24. The method of claim 20, further comprising selecting travel option amenities and service elements that match said one or more travel option preferences.

25. The method of claim 20, wherein said one or more travel option preferences comprise user review sentiments.

26. The method of claim 20, wherein said match employs the use of a machine learning algorithm that takes user feedback and preferences into account and adapts the matching process based on the preferences.

27. The method of claim 20, wherein said travel option is a hotel or flight.

28. A system for making travel arrangements for a user, comprising:
(a) a database of available travel options;
(b) a computer processor that is programmed to (i) conduct a search of said database directed to travel options that coincide with a travel schedule of said user, (ii) weigh available travel options by any two travel option attributes selected from star rating, user review, price and distance, and (iii) store weighted available travel options in memory; and
(c) an output that provides available travel options to said user.

29. The system of claim 28, wherein said computer processor is programmed to determine said travel schedule.

30. The system of claim 28, wherein said output is an electronic display on an electronic device of said user.

31. The system of claim 28, wherein said computer processor is programmed to compare said available travel options to travel preferences of said user.
